(19) United States
(12) Patent Application Publication
(10) Pub. No.: US 2005/0221099 A1
(43) Pub. Date: Oct. 6, 2005

(54) Protective structure, protected structure and methods

(75) Inventors: Brian Chalmers, Wrightwood, CA (US); Shay L. Harrison, East Greenbush, NY (US); Andrew J. Salem, Slingerlands, NY (US)

Correspondence Address: BURR & BROWN, PO BOX 7068, SYRACUSE, NY, 13261-7068, US

(73) Assignee: Blasch Precision Ceramics, Inc., Albany, NY (US)

(21) Appl. No.: 11/092,196

(22) Filed: Mar. 29, 2005

Related U.S. Application Data
(60) Provisional application No. 60/558,638, filed on Apr. 1, 2004.

(51) Int. Cl. B32B 9/04; A47G 1/12

(52) U.S. Cl. 428/447; 427/180; 427/387

(57) ABSTRACT

There are provided methods of forming a protective structure by applying or molding a protective structure-forming composition comprising at least one silicone elastomer precursor composition and at least one particulate ceramic material, and curing. There are also provided methods of protecting an element by applying and curing on a surface of the element or by curing, molding and then positioning the protective structure on a surface of the element. There are also provided protective structures and protected elements.

### CROSS-REFERENCE TO RELATED APPLICATIONS

This application claims the benefit of U.S. Provisional Patent Application No. 60/558,638, filed Apr. 1, 2004, the entirety of which is incorporated herein by reference.

### FIELD OF THE INVENTION

The present invention relates to protective structures for protecting surfaces of elements which handle or which would otherwise be exposed to harsh media, and methods of forming such protective structures, as well as protected elements and methods of protecting elements. In particular, the present invention is directed to protective structures formed by curing protective structure-forming compositions, methods of forming such protective structures, protected elements comprising such protective structures and methods of protecting elements with such protective structures.

### BACKGROUND OF THE INVENTION

There is a variety of low temperature, wear-resistant materials presently available. Well known examples of conventional wear-resistant materials include a variety of two-part thermoset epoxy compositions having a percentage of solids loading, typically with ceramic beads. Such epoxy compositions include a base and a curing agent, have curing cycles typically on the order of 24 hours, and can be applied with a trowel onto an application surface after mixing the two epoxy constituents. After curing, the epoxy presents a hard surface finish.

Such materials have two primary drawbacks. First, the two parts of the epoxy compositions must be mixed (typically thoroughly mixed), in the proper ratio, in order for the epoxy to cure correctly and completely. The mixing step can be time-consuming and requires adherence to the ratio formula.

A second problem with such epoxy materials is that once cured, in many cases, the epoxy coating is generally hard-faced, inflexible and brittle in nature, and is susceptible to failure due to cracking in the epoxy surface. Such tendencies typically increase when these epoxy materials are exposed to heat and/or abrasive particles over extended periods of time.

There is an ongoing need for reducing or eliminating the above-mentioned drawbacks, and the present invention is directed to satisfying those needs. In addition, the present invention is directed to methods of providing protective structures and protecting elements, as well as the resulting structures.

### SUMMARY OF THE INVENTION

The above-mentioned objectives are satisfied by the methods and structures according to the present invention. The present invention provides protective structures which protect surfaces of elements which are designed to handle (and/or which come into contact with) harsh media, e.g., slurries, gases and liquids containing wear-causing impinging and abrading particulate media (particularly where such slurries, gases or liquids are moving very rapidly), and/or chemically corrosive materials.

The protective structures according to the present invention provide a high ductility/low modulus matrix to absorb the kinetic energy of wear-causing impinging media, undergoing brittle cracking, together with a solid ceramic particulate material which is resistant to abrasion. The protective structure-forming compositions which are employed in accordance with the present invention are preferably single-component compositions.

The protective structure-forming compositions employed in accordance with the present invention are preferably applied onto a surface or surfaces of the element to be protected, and then cured to form a protective structure which is resistant to the harsh media. In another preferred method, a mold is partially or completely filled with a protective structure-forming composition and the protective structure-forming composition is cured to form a protective structure which is then positioned where it can protect a surface or surfaces of the element to be protected.

The protective structure-forming compositions employed in accordance with the present invention comprise at least one silicone elastomer precursor composition and at least one particulate ceramic material.

Accordingly, in a first aspect of the present invention, there is provided a method of forming a protective structure on a surface, comprising:
applying to the surface a protective structure-forming composition comprising at least one silicone elastomer precursor composition and at least one particulate ceramic material; and
curing the protective structure-forming composition to form a protective structure.

In a second aspect of the present invention, there is provided a method of forming a protective structure, comprising:
partially or completely filling a mold with a protective structure-forming composition comprising at least one silicone elastomer precursor composition and at least one particulate ceramic material; and
curing the protective structure-forming composition to form a protective structure.

In a third aspect of the present invention, there is provided a method of protecting an element, comprising:
applying a protective structure-forming composition to a surface of an element which handles at least one harsh media included in the group consisting of slurries, gases and liquids containing wear-causing impinging and abrading particulate media and/or chemically corrosive materials, the protective structure-forming composition comprising at least one silicone elastomer precursor composition and at least one particulate ceramic material; and
curing the protective structure-forming composition, thereby forming a protective structure which covers the surface and prevents the harsh media from coming into contact with the surface when the element is handling the harsh media.

In a fourth aspect of the present invention, there is provided a method of protecting an element, comprising:
molding a protective structure as described above; and
positioning the protective structure on a surface of an element which handles at least one harsh media included in the group consisting of slurries, gases and liquids containing wear-causing impinging and abrading particulate media and/or chemically corrosive materials, the protective structure-forming composition comprising at least one silicone elastomer precursor composition and at least one particulate ceramic material.

The present invention further provides methods as described above, further comprising subjecting the protective structure to at least one member selected from the group consisting of slurries, gases and liquids containing wear-causing impinging and abrading particulate media and/or chemically corrosive materials, with the result that the thickness of the protective structure decreases over time due to said subjecting said protective structure. As such, the protective structure functions as a sacrificial layer.

In a fifth aspect of the present invention, there is provided a protective structure comprising at least one silicone elastomer and at least one particulate ceramic material, the protective structure having a thickness of at least 500 microns.

In a sixth aspect of the present invention, there is provided a protected element comprising:
an element which handles harsh media, the element having a surface;
a protective structure covering the surface, whereby the protective structure prevents the harsh media from coming into contact with the surface, the protective structure comprising at least one silicone elastomer and at least one particulate ceramic material.

The invention may be more fully understood with reference to the following detailed description of the invention.

### DETAILED DESCRIPTION OF THE INVENTION

Silicone compositions have been used in the past as a sealant, i.e., to fill cracks or crevices, etc., or as an adhesive. In the present invention, on the other hand, silicone compositions are used to form a protective structure, i.e., a layer which protects the element on which the protective structure is positioned.

The protective structure according to the present invention provides resistance to chemical attack or thermal decomposition. In particular, the silicone matrix provides an elastic, low modulus component to absorb kinetic energy of impinging media, and the additive provides excellent resistance to abrasion. Furthermore, the silicone base is inherently resistant to chemical and/or thermal decomposition.

As noted above, the present invention provides methods of forming a protective structure on a surface by applying to the surface a protective structure-forming composition comprising at least one silicone elastomer precursor composition and at least one particulate ceramic material, and curing the protective structure-forming composition to form a protective structure.

The protective structure-forming composition according to the present invention comprises at least one silicone elastomer precursor composition and at least one particulate ceramic material. The protective structure-forming composition according to the present invention is preferably putty-like, such that it can readily be applied to a surface using, e.g., a putty knife or other troweling device. Preferably, the protective structure-forming composition according to the present invention readily adheres to most surfaces, e.g., metal surfaces, alloy surfaces, ceramic surfaces and concrete surfaces.

The silicone elastomer precursor composition according to the present invention can generally be any composition which, upon curing, produces one or more silicone elastomer. A wide variety of such compositions are well known to those of skill in the art. Such compositions contain one or more reactive silicon-containing compounds (e.g., any of a variety of siloxanes and silanes) which produce one or more silicone elastomer upon reaction, and such compositions can further contain any of a number of additional ingredients, including condensation catalysts, fillers, plasticizers, cross-linkers, stabilizers, cure accelerators, scavengers and adhesion promoters.

Persons of skill in the art can readily tailor silicone elastomer precursor compositions to provide any of a wide variety of specific characteristics, e.g., to achieve lower viscosity (for example, to enable the protective structure-forming composition to be sprayed), to cure more slowly (for example, in order to provide longer shelf life), etc.

The silicone elastomer precursor composition used in accordance with this aspect of the present invention is preferably a room temperature vulcanizing (RTV) silicone. Such compositions generally cure automatically upon being exposed to ambient temperature and humidity. Preferably, the protective structure-forming compositions for use in accordance with the present invention are compounded under a dry, inert gas, such as nitrogen and packaged under vacuum to avoid the introduction of ambient moisture that will initiate curing. Typical shelf life of protective structure-forming compositions according to the present invention, in an unopened vacuumed seal container, is at least six months.

The silicone elastomer precursor composition used in accordance with the present invention is preferably a single-component composition--that is, the composition does not have two parts which must be kept separate until it is desired to begin curing. Where a single-component composition is used according to the present invention, the precursor composition is preferably kept sealed before being used.

Alternatively, the silicone elastomer precursor composition can contain two or more components (i.e., can be a two-component, or more than two-component, composition), in which (as is well known in the art) the two or more components are kept separate until it is desired to cure the composition, at which time the two or more components are mixed. As is well known in the art, such compositions may contain any of a variety of additives, e.g., polymerization initiators, condensation catalysts, fillers, plasticizers, cross-linkers, stabilizers, cure accelerators, scavengers and adhesion promoters. As is well known in the art, with many such multiple component precursor compositions, heating is required or desired in order to stimulate and/or accelerate reaction.

The silicone elastomer precursor composition according to the present invention preferably comprises at least one methoxy group (or groups)-containing compound. The presence of a methoxy group (or groups)-containing compound (instead of, e.g., an acetoxy group (or groups)-containing compounds) in the precursor composition evolves essentially odorless methanol upon curing and thereby avoids the production of pungent odors (such as that of acetic acid produced during curing where an acetoxy group(s)-containing compound is present). The use of methoxy or other curing compounds with neutral byproducts avoids depositing corrosive acetic acid on the protected surface. In addition, the presence of a methoxy group(s)-containing compound provides long shelf life (e.g., in comparison to compositions which include an acetoxy group(s)-containing compound).

Preferred examples of silicone elastomer precursor compositions for use in accordance with the present invention include those which, upon curing, form at least one silicone elastomer selected from the group consisting of polydimethylsiloxane or polydimethyl siloxane substituted with phenyl, fluorine, or any other substituent or substituents, a variety of which are well known to those skilled in the art, to impart chemical, physical, or structural stability known to those skilled in the art.

The silicone elastomer precursor composition according to the present invention preferably comprises an antioxidant additive, preferably iron oxide.

The particulate ceramic material can comprise generally any suitable ceramic material, a wide variety of which are readily known to those of skill in the art. For example, the ceramic may be any of the various metal oxides or other natural or non-natural ceramic materials. A preferred ceramic material for use as the particulate ceramic material according to the present invention is alumina (Al₂O₃). Other preferred ceramics include silicon carbide and fumed silica.

The particles of ceramic material preferably comprise a distribution of particle sizes, e.g., from −100 mesh to submicron size. Such a particle size distribution provides good particle packing. In addition, such a particle size distribution reduces the effects of the ceramic material on the flow of the uncured protective structure-forming composition at a given loading of ceramic material, compared, e.g., to where alumina of a single −48/+100 mesh cut is used. Alternatively, a substantial portion of the particles of ceramic material (or all of the particles) can be of similar size.

The amount of ceramic particles in the protective structure-forming composition is preferably from about 20% to about 75% by weight, most preferably about 40% by weight, of the protective structure-forming composition, i.e., the protective structure-forming composition preferably includes from about 25 to about 300 parts by weight of ceramic particles per 100 parts by weight of silicone elastomer precursor composition, or equivalently from about 33 to about 400 parts by weight of silicone elastomer precursor composition per 100 parts by weight of ceramic particles. The relative amounts of components can be selected within the above range depending on the desired result. For example, different relative amounts of the ceramic can be used to vary the rheological properties of the precursor materials and/or mechanical and thermal properties of the composition and the cured protective structure, e.g., higher ceramic content provides increased stiffness and strength.

An example of a suitable protective structure-forming composition in accordance with the present invention is a composition containing about 0.1 to about 0.5 weight percent methyltrimethoxysilane, about 0.1 to about 0.5 weight percent 1,3,5-tris (trimethoxysylpropyl) isocyanurate, about 8 to about 12 weight percent dimethylpolysiloxane, about 12 to about 22 weight percent silicon dioxide, about 25 to about 35 weight percent dimethyl polysiloxane silanol and about 30 to about 40 weight percent alumina.

In accordance with this aspect of the present invention, the protective structure-forming composition can be applied to the surface of the element to be protected by any suitable application method. For example, the protective structure-forming composition can be applied by being troweled (i.e., applied using a putty knife or other trowel-like tool) onto the surface of the element to be protected. Preferably, prior to applying the protective structure-forming composition, the surface of the element is thoroughly cleaned of loose material, dust and grease. Preferably, the protective structure-forming composition is applied to the surface of the element in a well-ventilated area.

Another example of a suitable application method is by spraying the protective structure-forming composition onto the surface of the element to be protected. Where the protective structure is to be sprayed, the protective structure-forming composition is preferably of a lower viscosity. As noted above, persons of skill in the art are familiar with a variety of ways by which the protective structure-forming composition can be formulated so as to have lower viscosity, and any of these are within the scope of the present invention.

Typical coverage area of protective structure-forming compositions according to the present invention, as described herein, is within the range of from about 51.6 ft²/gallon to about 13.6 ft²/gallon, e.g., about 13.6 ft²/gallon, assuming three millimeter thickness.

Preferably, curing is carried out by subjecting the protective structure-forming composition to ambient temperature and moisture conditions. Alternatively, in another preferred aspect of the invention, curing is carried out by subjecting the protective structure-forming composition to elevated temperature.

Protective structure-forming compositions in accordance with this aspect of the present invention typically fully cure within about 24 hours after application at about 77 degrees F./50% relative humidity. Curing times at other conditions will vary. The protective structure-forming composition is preferably exposed to an unimpeded air environment during curing in order to achieve complete curing.

The protective structure-forming composition according to this aspect of the present invention can alternatively be a composition which does not cure under ambient conditions. For example, the protective-structure-forming composition can require elevated temperatures for curing.

As noted above, the present invention is also directed to a method of protecting an element which handles at least one harsh media included in the group consisting of slurries, gases and liquids containing wear-causing impinging and abrading particulate media and/or chemically corrosive materials, the method comprising applying to a surface of the element a protective structure-forming composition as described above in connection with the first aspect of this invention, and curing (in a manner as described above in connection with the first aspect of this invention) the protective structure-forming composition to form a protective structure which covers the surface and prevents the harsh media from coming into contact with the surface when the element is handling the harsh media.

The expression “harsh media,” as used herein, includes slurries, gases and liquids containing wear-causing impinging and abrading particulate media (particularly where such slurries, gases or liquids are moving very rapidly), and/or chemically corrosive materials. For example, representative examples of impinging and abrading particulate media can include coal, cement sawdust, etc. Representative examples of chemically corrossive materials include most common acids, bases and organics.

As noted above, the present invention is also directed to a method of forming a protective structure, comprising partially or completely filling a mold with a protective structure-forming composition comprising at least one silicone elastomer precursor composition and at least one particulate ceramic material, and curing the protective structure-forming composition to form a protective structure. In accordance with this aspect of the present invention, the protective structure-forming composition, the silicone elastomer precursor composition(s) and the particulate ceramic material(s) can be selected from among those discussed above in connection with the first aspect of the present invention. The curing of the protective structure-forming composition is preferably carried out by pressure molding, preferably at elevated temperature, although such curing can be carried out as discussed above in connection with the first aspect of the present invention. As noted above, the present invention is further directed to a method of protecting an element, comprising forming a protective structure as described above in this paragraph, and positioning the protective structure on a surface of an element which handles at least one harsh media.

The protective structures in accordance with the present invention (and those formed according to the methods described above) provide excellent abrasion/wear resistance. The protective structures described above provide continuous use temperature capability up to 500 degrees F. and in some cases even higher. The protective structures described above have outstanding chemical and physical stability over their temperature range. If it is desired that the protective structure be able to withstand higher temperatures, the components contained in the silicone elastomer precursor composition can be selected in accordance with well known principles to enable the protective structure to withstand such higher temperatures.

The protective structures described above thus provide high ductility/low modulus matrix to absorb the kinetic energy of wear-causing impinging media, together with a solid particulate ceramic material which is resistant to abrasion. The protective structures described above remain pliable when cured, thus absorbing impact and improving abrasion resistance properties.

Preferably, (especially where the silicone elastomer precursor composition is an RTV composition), the composition is applied in a thickness (and so the protective structure has a thickness) in the range of from about 500 microns to about 4 mm, more preferably about 700 microns to about 3 mm. For example, suitable thicknesses can be 600 microns, 700 microns, 800 microns, 900 microns, 1 mm, 2 mm, 3 mm, etc.

Where the protective structure is formed by molding, as described above, the silicone elastomer precursor composition (or compositions) is placed in the mold to a thickness of at least 500 micrometers or larger, whereby the cured protective structure has a thickness of at least 500 micrometers. For example, suitable thicknesses can be 600 microns, 700 microns, 800 microns, 900 microns, 1 mm, 2 mm, 3 mm, 4 mm, 5 mm, 1 cm, 2 cm, 5 cm, 10 cm etc.

The protective structures of the present invention are generally less susceptible than ceramics to crack propagation (i.e., once a crack forms in a ceramic, the crack tends to lengthen relatively quickly).

Using ASTM test method C704, where a surface is subjected to high pressure (i.e., directed out of an air gun nozzle at the sample surface with a backing pressure of 65 psi), 90 degree impingement of 1 Kg of silicon carbide grit (the impingement process typically lasting about 7½ minutes), the protective structures according to the present invention (applied by spatula to a silicon carbide ceramic plate) typically show volume loss (detected by measuring the change in weight of the test specimens) on the order of tenths of a cubic centimeter or no measurable volume loss. A typical epoxy coating, Devcon Silicon Carbide Putty 10050, on the other hand, shows 1.75 cm³ loss. Uncoated high alloy, hardened steels show loss on the order of tenths of a cubic centimeter (e.g., NiHard high nickel content stainless steel alloy shows about 0.060 cm³ loss).

Typical properties of protective structures according to the present invention, as described herein, include the following:
Shore A hardness of about 55 (test method: ASTM D2240);
tensile psi of about 275 (test method: ASTM D412);
elongation % of about 400 (test method: ASTM D412);
tear “B” ppi of about 70 (test method: ASTM D624);
specific gravity of about 1.4 gm/cm³ (test method: ASTM D792);
peel strength of about 80 lb/in. (test method: ASTM DI 002);
work life of about 15 min.;
skim over time at 32 degrees C. of about 15 min.; and
consistency of “no sag.”

Twenty-eight day chemical exposure of protective structures according to the present invention to each of the following chemical environments was typically excellent:
40% nitric acid;
50% sulfuric acid;
10% nitric acid
10% hydrochloric acid;
10% sulfuric acid;
10% sodium hydroxide;
pH=4;
pH=10; and
pH=12.

As noted above, the present invention is also directed to a protected element comprising an element which handles harsh media, and a protective structure (as described above) covering a surface of the element, whereby the protective structure prevents the harsh media from coming into contact with the surface.

Examples of elements which can be protected in accordance with the present invention include pumps, slurry tanks, cyclones, pipes, ash lines, conveyors, exhaust fans, cement handling devices (e.g., cement mining equipment, cement sawmills, cement mixers, cement chutes for guiding cement exiting from cement mixers—i.e., cement chutes and anything upstream from them) and chemical process machinery (e.g., scrubbers), etc. Such elements can include surfaces made of metal, alloy, ceramic, concrete, etc. The skilled artisan can readily envision multitudes of other elements which can be so protected, and such protection of all such elements, and the resulting protected elements, are included in the present invention.

Those of skill in the art can readily see that the present invention, as described above, is highly effective for protecting and/or repairing elements, restoring worn and/or eroded equipment to extend operating life, repairing linings damaged by abrasion, repairing tube sheets, and/or reducing downtime and part replacement costs, as well as a variety of other desirable effects or results.

1. A method of forming a protective structure on a surface, comprising:
applying to said surface a protective structure-forming composition comprising at least one silicone elastomer precursor composition and at least one particulate ceramic material; and
curing said protective structure-forming composition to form a protective structure.

2. A method as recited in claim 1, wherein said protective structure has a thickness of at least 500 microns.

3. A method as recited in claim 1, wherein said surface is on an element which handles harsh media.

4. A method as recited in claim 3, wherein said element is selected from the group consisting of pumps, slurry tanks, cyclones, pipes, ash lines, conveyors, exhaust fans, cement handling devices and chemical process machinery.

5. A method as recited in claim 1, wherein said at least one silicone elastomer precursor composition, upon curing, forms at least one silicone elastomer selected from the group consisting of polydimethylsiloxane and polydimethyl siloxane substituted with phenyl, fluorine, or other substituent or substituents.

6. A method as recited in claim 1, wherein said at least one ceramic material comprises at least one member selected from the group consisting of metal oxides.

7. A method as recited in claim 1, further comprising subjecting said protective structure to at least one member selected from the group consisting of slurries, gases and liquids containing wear-causing impinging and abrading particulate media and/or chemically corrosive materials.

8. A method as recited in claim 7, wherein a thickness of said protective structure decreases over time due to said subjecting said protective structure.

9. A method as recited in claim 1, wherein said curing is carried out by subjecting said protective structure-forming composition to ambient conditions.

10. A method as recited in claim 1, wherein said curing is carried out by subjecting said protective structure-forming composition to elevated temperature.

11. A method as recited in claim 1, wherein said ceramic material is present in said protective structure-forming composition in an amount in the range of from about 20 to about 75 percent by weight of said protective structure-forming composition.

12. A method as recited in claim 1, wherein said ceramic material comprises particles having sizes in the range of from about −100 mesh to about 1 micron.

13. A method of forming a protective structure, comprising:
at least partially filling a mold with a protective structure-forming composition comprising at least one silicone elastomer precursor composition and at least one particulate ceramic material; and
curing said protective structure-forming composition to form a protective structure.

14. A method as recited in claim 13, wherein said protective structure has a thickness of at least 500 microns.

15. A method as recited in claim 13, wherein said at least one silicone elastomer precursor composition, upon curing, forms at least one silicone elastomer selected from the group consisting of polydimethylsiloxane and polydimethyl siloxane substituted with phenyl, fluorine, or other substituent or substituents.

16. A method as recited in claim 13, wherein said at least one ceramic material comprises at least one member selected from the group consisting of metal oxides.

17-21. (canceled)

22. A method of protecting an element, comprising:
applying a protective structure-forming composition to a surface of an element which handles at least one harsh media included in the group consisting of slurries, gases and liquids containing wear-causing impinging and abrading particulate media and/or chemically corrosive materials, said protective structure-forming composition comprising at least one silicone elastomer precursor composition and at least one particulate ceramic material; and
curing said protective structure-forming composition, thereby forming a protective structure which covers said surface and prevents said harsh media from coming into contact with said surface when said element is handling said harsh media.

23-32. (canceled)

33. A method of protecting an element, comprising:
forming a protective structure according to a method as recited in claim 13; and
positioning said protective structure on a surface of an element which handles at least one harsh media included in the group consisting of slurries, gases and liquids containing wear-causing impinging and abrading particulate media and/or chemically corrosive materials, said protective structure-forming composition comprising at least one silicone elastomer precursor composition and at least one particulate ceramic material.

34-37. (canceled)

38. A protective structure comprising at least one silicone elastomer and at least one particulate ceramic material, said protective structure having a thickness of at least 500 microns.

39-44. (canceled)

45. A protected element comprising:
an element which handles harsh media, said element having a surface;
a protective structure covering said surface, whereby said protective structure prevents said harsh media from coming into contact with said surface, said protective structure comprising at least one silicone elastomer and at least one particulate ceramic material.

46-51. (canceled)
